(19) United States
(12) Patent Application Publication
(10) Pub. No.: US 2025/0293381 A1
(43) Pub. Date: Sep. 18, 2025

(54) POWER STORAGE DEVICE AND VEHICLE

(71) Applicant: TOYOTA JIDOSHA KABUSHIKI KAISHA, Toyota-shi (JP)

(72) Inventors: Shigeyuki INOUE, Toyota-shi (JP); Naoya KAWAMOTO, Nisshin-shi (JP); Takahito SAKURABA, Seto-shi (JP); Kenichi KAKISHITA, Nagoya-shi (JP); Kohei TAKASE, Susono-shi (JP); Kai MIYAMURA, Toyota-shi (JP); Kazuya KUMAZAWA, Nagoyo-shi (JP)

(73) Assignee: TOYOTA JIDOSHA KABUSHIKI KAISHA, Toyota-shi (JP)

(21) Appl. No.: 19/058,854

(22) Filed: Feb. 20, 2025

(30) Foreign Application Priority Data
Mar. 12, 2024 (JP) 2024-038135

(51) Int. Cl. H01M 50/293; H01M 50/238; H01M 50/249; H01M 50/264; H01M 50/273

(52) U.S. Cl. CPC H01M 50/293; H01M 50/249; H01M 50/264; H01M 50/273; H01M 50/238; H01M 2220/20

(57) ABSTRACT

A plurality of cells are arranged in a first direction, the first direction being a direction along a horizontal direction. Each of the plurality of cells includes an electrode assembly and a cell case that houses the electrode assembly. The cell case includes an upper surface portion facing upward. The upper surface portion includes a first end edge and a second end edge. The first end edge is an end edge on one side in the first direction. The second end edge is an end edge on the other side in the first direction. The first end edge and the second end edge extend along a second direction, the second direction being a direction along the horizontal direction and orthogonal to the first direction. A buffer portion covers the first end edge and the second end edge in each of the plurality of cells.

### CROSS REFERENCE TO RELATED APPLICATIONS

This nonprovisional application is based on Japanese Patent Application No. 2024-038135 filed on Mar. 12, 2024 with the Japan Patent Office, the entire contents of which are hereby incorporated by reference.

### BACKGROUND

### Field

The present disclosure relates to a power storage device and a vehicle.

### Description of the Background Art

Japanese Patent Laying-Open No. 2020-142589 discloses that a battery pack is disposed on the lower side of a floor panel.

### SUMMARY

A structure of a power storage device mountable on a vehicle, which can achieve higher energy density of the power storage device, has been considered. For example, it has been considered to dispose a power storage device below a floor panel and as close as possible to the floor panel, or to cause a power storage device itself to constitute a part of a floor panel. However, when the power storage device is designed as described above, a load may be input to an upper surface of a cell in a pack of the power storage device due to a load from the inside of a vehicle cabin, i.e., a load from the upper side.

The present disclosure has been made in view of the above-described problem, and an object of the present disclosure is to provide a power storage device in which input of a load to an upper surface of a cell from the upper side can be reduced.

A power storage device according to an aspect of the present disclosure is a power storage device mountable on a vehicle. The power storage device includes: a power storage module; and a buffer portion. The power storage module includes a plurality of cells. The buffer portion is disposed on the power storage module. The plurality of cells are arranged in a first direction, the first direction being a direction along a horizontal direction. Each of the plurality of cells includes an electrode assembly and a cell case that houses the electrode assembly. The cell case includes an upper surface portion facing upward. The upper surface portion includes a first end edge and a second end edge. The first end edge is an end edge on one side in the first direction. The second end edge is an end edge on the other side in the first direction. The first end edge and the second end edge extend along a second direction, the second direction being a direction along the horizontal direction and orthogonal to the first direction. The buffer portion covers the first end edge and the second end edge in each of the plurality of cells.

Preferably, the power storage device according to the aspect of the present disclosure further includes a pack. The pack houses the power storage module and the buffer portion. The pack is fixable to a vehicle body of the vehicle. The pack includes an upper plate portion and a lower plate portion. The upper plate portion is disposed above the buffer portion. The lower plate portion is disposed below the power storage module. At least a part of the buffer portion is made of a material having rigidity higher than that of the upper plate portion.

Preferably, in the power storage device according to the aspect of the present disclosure, the buffer portion includes: a restraint member; and a plate member. The restraint member extends from one side to the other side of the power storage module in the first direction. The restraint member covers at least a part of the first end edge and at least a part of the second end edge in each of the plurality of cells. The plate member is located above the plurality of cells and the restraint member and is provided on the restraint member.

Preferably, the power storage device according to the aspect of the present disclosure further includes a pack. The pack houses the power storage module and the buffer portion. The pack is fixable to a vehicle body of the vehicle. The pack includes an upper plate portion and a lower plate portion. The upper plate portion is disposed above the buffer portion. The lower plate portion is disposed below the power storage module. The plate member is made of a material having rigidity higher than that of the upper plate portion.

Preferably, in the power storage device according to the aspect of the present disclosure, in each of the plurality of cells, the upper surface portion further includes a third end edge and a fourth end edge. The third end edge is an end edge on one side in the second direction. The fourth end edge is an end edge on the other side in the second direction. The third end edge and the fourth end edge extend along the first direction. The restraint member includes a first restraint member and a second restraint member. The first restraint member extends from one side to the other side of the power storage module in the first direction. The first restraint member covers a part of the first end edge, a part of the second end edge, and the third end edge in each of the plurality of cells. The second restraint member extends from one side to the other side of the power storage module in the first direction. The second restraint member covers another part of the first end edge, another part of the second end edge, and the fourth end edge in each of the plurality of cells.

Preferably, in the power storage device according to the aspect of the present disclosure, the first restraint member and the second restraint member are spaced apart from each other. Between the first restraint member and the second restraint member, the plate member faces the upper surface portion of each of the plurality of cells with a gap being interposed.

Preferably, in the power storage device according to the aspect of the present disclosure, the first restraint member and the second restraint member are spaced apart from each other. Between the first restraint member and the second restraint member, the plate member is in contact with the first end edge and the second end edge in each of the plurality of cells.

A vehicle according to an aspect of the present disclosure includes: the above-described power storage device; and a vehicle body having the power storage device fixed thereto. A front-rear direction of the vehicle body is the first direction in the power storage device. The vehicle body includes a cross member extending in a left-right direction of the vehicle body. The cross member is located above the power storage module and the buffer portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a vehicle on which a power storage device according to an embodiment of the present disclosure is mounted.

FIG. 2 is a schematic perspective view showing a vehicle body of the vehicle on which the power storage device according to the embodiment of the present disclosure is mounted.

FIG. 3 is a schematic cross-sectional view of a part of the vehicle in FIG. 1 when viewed in the direction of an arrow III-III.

FIG. 4 is a plan view showing the power storage device according to the embodiment of the present disclosure together with cross members of the vehicle body.

FIG. 5 is an exploded perspective view showing the power storage device according to the embodiment of the present disclosure.

FIG. 6 is a schematic perspective view when a plurality of cells of a power storage module are spaced apart from each other.

FIG. 7 is a cross-sectional view of the power storage device in FIG. 4 when viewed in the direction of an arrow VII-VII.

FIG. 8 is a schematic cross-sectional view of the power storage module and a buffer portion.

FIG. 9 is a schematic cross-sectional view of a power storage module and a buffer portion according to a modification.

### DESCRIPTION OF THE PREFERRED EMBODIMENTS

Hereinafter, a power storage device and a vehicle according to an embodiment of the present disclosure will be described with reference to the drawings. The same or corresponding portions in the drawings are denoted by the same reference characters and description thereof will not be repeated.

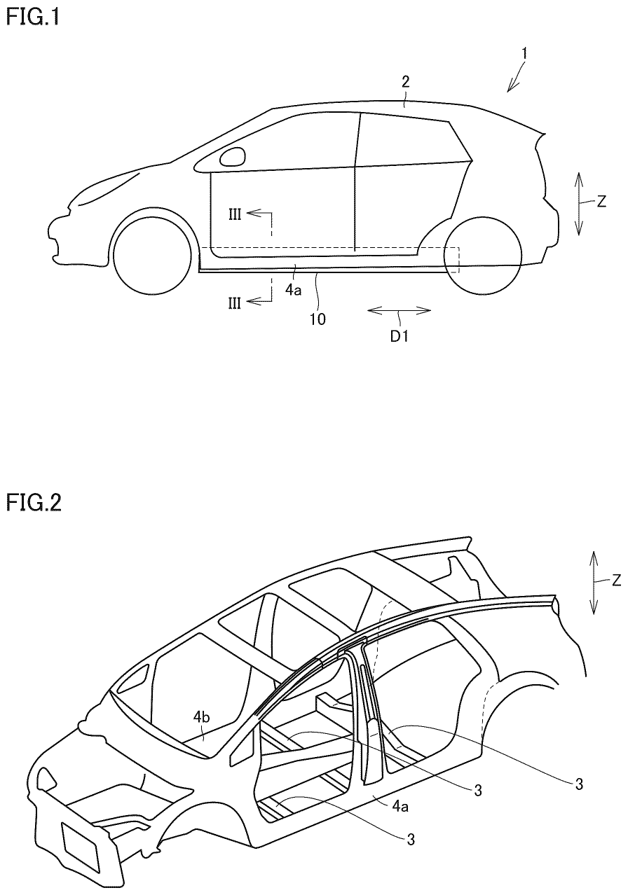

FIG. 1 is a schematic view showing a vehicle on which a power storage device according to an embodiment of the present disclosure is mounted. As shown in FIG. 1, a power storage device 10 according to the embodiment of the present disclosure is power storage device 10 mountable on a vehicle 1. Vehicle 1 will be described first.

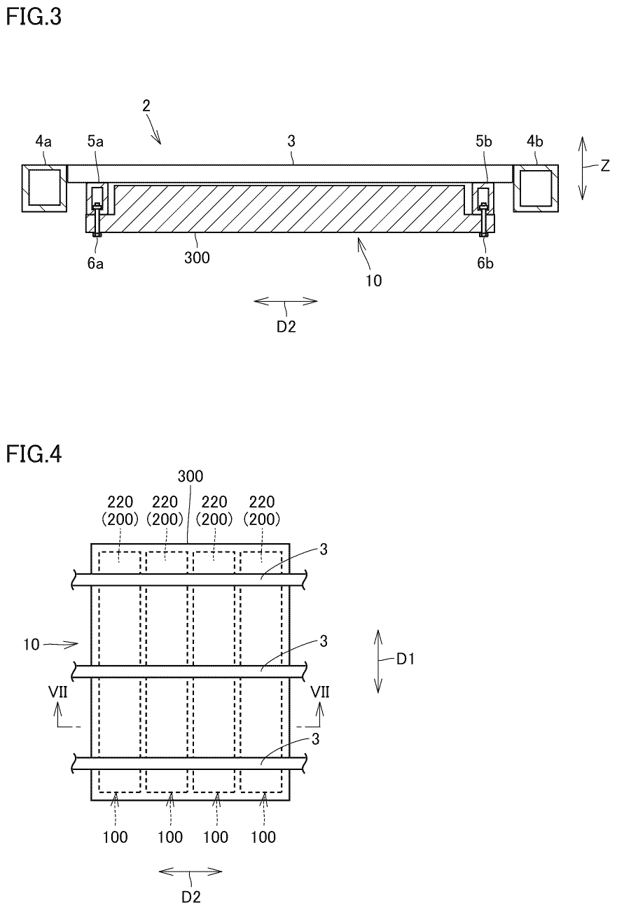

Vehicle 1 according to the present embodiment is, for example, an electrically powered vehicle such as a battery electric vehicle or a hybrid electric vehicle that can be driven by a motor. FIG. 2 is a schematic perspective view showing a vehicle body of the vehicle on which the power storage device according to the embodiment of the present disclosure is mounted. FIG. 3 is a schematic cross-sectional view of a part of the vehicle in FIG. 1 when viewed in the direction of an arrow III-III. As shown in FIGS. 1 to 3, vehicle 1 according to the embodiment of the present disclosure includes power storage device 10 and a vehicle body 2 having power storage device 10 fixed thereto. A front-rear direction of vehicle body 2 is parallel to a below-described first direction D1 in power storage device 10. The front-rear direction of vehicle body 2 is a front-rear direction of vehicle 1.

Vehicle body 2 includes, as frame members of vehicle 1, a plurality of cross members 3, a left side sill 4a, a right side sill 4b, a left side member 5a, and a right side member 5b.

Each of the plurality of cross members 3 extends in a left-right direction of vehicle body 2. The left-right direction of vehicle body 2 is parallel to a below-described second direction D2 in power storage device 10. The left-right direction of vehicle body 2 is a left-right direction of vehicle 1. The left-right direction of vehicle body 2 is a vehicle width direction of vehicle 1. The plurality of cross members 3 are arranged in first direction D1. Vehicle body 2 may include only one cross member 3.

Left side sill 4a is disposed on the left side of vehicle 1 in the left-right direction. Left side sill 4a extends in the front-rear direction of vehicle 1. Right side sill 4b is disposed on the right side of vehicle 1 in the left-right direction. Right side sill 4b extends in the front-rear direction of vehicle 1. Each of the plurality of cross members 3 extends from the inner side of left side sill 4a to the inner side of right side sill 4b.

Left side member 5a is disposed on the left side of vehicle 1 in the left-right direction. Left side member 5a extends in the front-rear direction of the vehicle. Left side member 5a is disposed closer to the vehicle center in the vehicle width direction than left side sill 4a. Right side member 5b is disposed on the right side of vehicle 1 in the left-right direction. Right side member 5b is disposed closer to the vehicle center in the vehicle width direction than right side sill 4b.

Details of power storage device 10 according to the embodiment of the present disclosure will now be described. FIG. 4 is a plan view showing the power storage device according to the embodiment of the present disclosure together with the cross members of the vehicle body. FIG. 5 is an exploded perspective view showing the power storage device according to the embodiment of the present disclosure.

As shown in FIGS. 3 to 5, power storage device 10 includes a plurality of power storage modules 100, a plurality of buffer portions 200 and a pack 300. Cross members 3 are located above the plurality of power storage modules 100, the plurality of buffer portions 200 and pack 300.

Each of the plurality of power storage modules 100 extends in first direction D1. First direction D1 is a direction along a horizontal direction. When viewed in an up-down direction Z, each of the plurality of power storage modules 100 is disposed to intersect at least one cross member 3. When viewed in up-down direction Z, each of the plurality of power storage modules 100 is disposed to intersect the plurality of cross members 3. The plurality of power storage modules 100 are arranged in second direction D2. Second direction D2 is a direction along the horizontal direction. Second direction D2 is a direction orthogonal to first direction D1. In the present embodiment, the plurality of power storage modules 100 are arranged only in second direction D2.

Power storage device 10 may include at least one power storage module 100. Power storage device 10 may include only one power storage module 100. The plurality of power storage modules 100 may be arranged in first direction D1. The plurality of power storage modules 100 may be arranged in first direction D1 and arranged in second direction D2. The plurality of power storage modules 100 may be arranged only in first direction D1.

Next, one power storage module 100 of the plurality of power storage modules 100 will be described. At least one of the plurality of power storage modules 100 may have a configuration of a power storage module described below. Each of all power storage modules 100 in power storage device 10 may have a configuration of a power storage module described below.

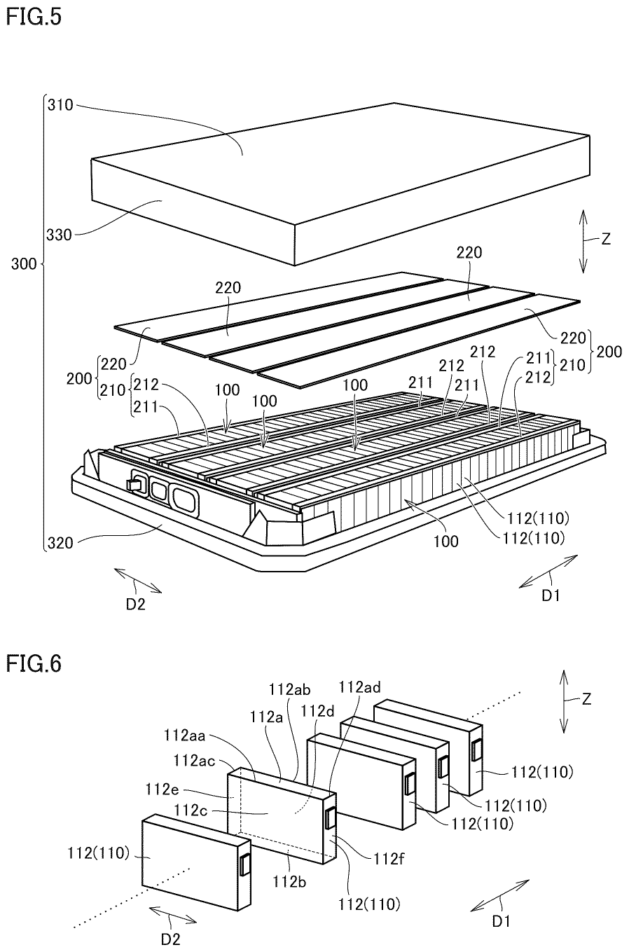

Power storage module 100 includes a plurality of cells 110. FIG. 6 is a schematic perspective view when the plurality of cells of the power storage module are spaced apart from each other. As shown in FIGS. 5 and 6, the plurality of cells 110 are arranged in first direction D1.

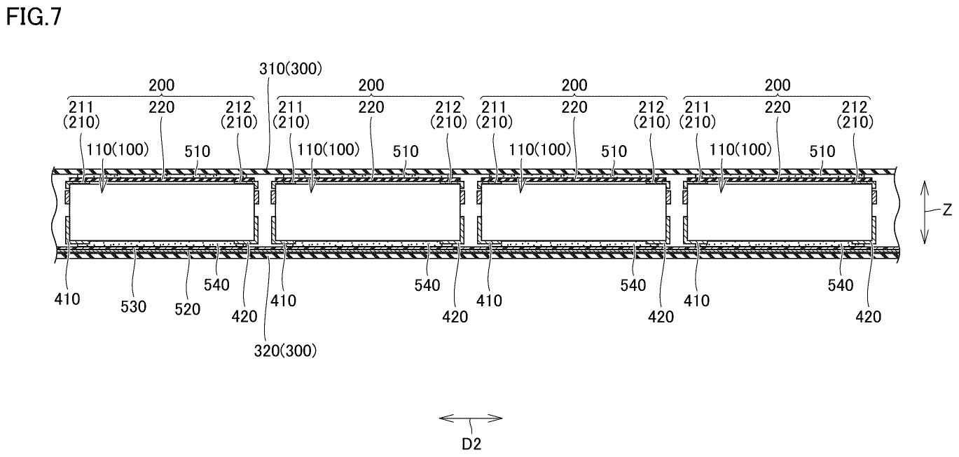

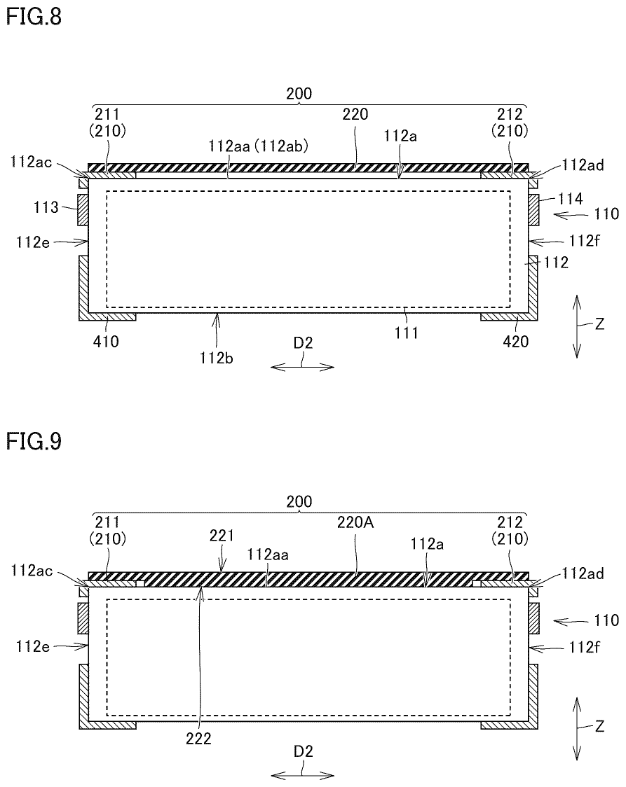

FIG. 7 is a cross-sectional view of the power storage device in FIG. 4 when viewed in the direction of an arrow VII-VII. FIG. 8 is a schematic cross-sectional view of the power storage module and the buffer portion. FIG. 8 is illustrated in the same cross-sectional view as FIG. 7. As shown in FIGS. 6 to 8, each of the plurality of cells 110 has an electrode assembly 111, a cell case 112, a first external terminal 113, and a second external terminal 114. Each of the plurality of cells 110 is, for example, a non-aqueous electrolyte secondary battery such as a lithium ion secondary battery.

Electrode assembly 111 includes a positive electrode layer, a negative electrode layer and a separator (all are not shown). The separator is interposed between the positive electrode layer and the negative electrode layer. The positive electrode layer and the negative electrode layer may be stacked in first direction D1 with the separator interposed therebetween. The positive electrode layer and the negative electrode layer may be wound with second direction D2 as an axial direction, in a state where the separator is interposed therebetween.

Cell case 112 houses electrode assembly 111. Cell case 112 may be made of metal such as aluminum or an aluminum alloy. Cell case 112 has a so-called rectangular shape. Cell case 112 has an upper surface portion 112a, a lower surface portion 112b, a first side surface portion 112c, a second side surface portion 112d, a first end surface portion 112e, and a second end surface portion 112f.

Upper surface portion 112a faces upward. Upper surface portion 112a has a first end edge 112aa, a second end edge 112ab, a third end edge 112ac, and a fourth end edge 112ad.

First end edge 112aa is an end edge on one side in first direction D1. Second end edge 112ab is an end edge on the other side in first direction D1. First end edge 112aa and second end edge 112ab extend along second direction D2.

Third end edge 112ac is an end edge on one side in second direction D2. Fourth end edge 112ad is an end edge on the other side in second direction D2. Third end edge 112ac and fourth end edge 112ad extend along first direction D1.

Lower surface portion 112b faces downward. First side surface portion 112c faces one side in first direction D1. Second side surface portion 112d faces the other side in first direction D1. First side surface portion 112c and second side surface portion 112d extend in up-down direction Z. First side surface portion 112c and second side surface portion 112d connect upper surface portion 112a and lower surface portion 112b.

First side surface portion 112c is connected to first end edge 112aa of upper surface portion 112a. First end edge 112aa may be formed by bending first side surface portion 112c and upper surface portion 112a that are integrally molded. First end edge 112aa may be formed by welding first side surface portion 112c and upper surface portion 112a that are separately molded.

Second side surface portion 112d is connected to second end edge 112ab of upper surface portion 112a. Second end edge 112ab may be formed by bending second side surface portion 112d and upper surface portion 112a that are integrally molded. Second end edge 112ab may be formed by welding second side surface portion 112d and upper surface portion 112a that are separately molded.

A surface area of first side surface portion 112c and a surface area of second side surface portion 112d are larger than a surface area of upper surface portion 112a and are larger than a surface area of lower surface portion 112b.

First end surface portion 112e faces one side in second direction D2. Second end surface portion 112f faces the other side in second direction D2. First end surface portion 112e and second end surface portion 112f extend in up-down direction Z. First end surface portion 112e and second end surface portion 112f connect upper surface portion 112a and lower surface portion 112b.

First end surface portion 112e is connected to third end edge 112ac of upper surface portion 112a. Third end edge 112ac may be formed by bending first end surface portion 112e and upper surface portion 112a that are integrally molded. Third end edge 112ac may be formed by welding first end surface portion 112e and upper surface portion 112a that are separately molded.

Second end surface portion 112f is connected to fourth end edge 112ad of upper surface portion 112a. Fourth end edge 112ad may be formed by bending second end surface portion 112f and upper surface portion 112a that are integrally molded. Fourth end edge 112ad may be formed by welding second end surface portion 112f and upper surface portion 112a that are separately molded.

A surface area of first end surface portion 112e and a surface area of second end surface portion 112f are smaller than a surface area of upper surface portion 112a and are smaller than a surface area of lower surface portion 112b.

First external terminal 113 is provided on first end surface portion 112e. Second external terminal 114 is provided on second end surface portion 112f. One of first external terminal 113 and second external terminal 114 is electrically connected to the positive electrode layer of electrode assembly 111. The other of first external terminal 113 and second external terminal 114 is electrically connected to the negative electrode layer of electrode assembly 111.

As shown in FIG. 4, each of the plurality of buffer portions 200 extends in first direction D1. When viewed in up-down direction Z, the plurality of buffer portions 200 are arranged in second direction D2. In the present embodiment, the plurality of buffer portions 200 are arranged only in second direction D2. Power storage device 10 may include at least one buffer portion 200.

As shown in FIGS. 4 to 8, the plurality of buffer portions 200 are disposed on the plurality of power storage modules 100 to correspond to the plurality of power storage modules 100 in one-to-one relationship. In the following description, one buffer portion 200 of the plurality of buffer portions 200 will be described. A configuration of power storage module 100 in the following description is a configuration of power storage module 100 corresponding to buffer portion 200 described below. At least one of the plurality of buffer portions 200 may have a configuration of buffer portion 200 described below. Each of all buffer portions 200 in power storage device 10 may have the configuration of buffer portion 200 described below.

Buffer portion 200 covers first end edge 112aa and second end edge 112ab in each of the plurality of cells 110. Furthermore, buffer portion 200 covers third end edge 112ac and fourth end edge 112ad in each of the plurality of cells 110.

Buffer portion 200 has a restraint member 210 and a plate member 220. Restraint member 210 extends from one side to the other side of power storage module 100 in first direction D1. A load is applied to the plurality of cells 110 in first direction D1 by restraint member 210. Relative positions of the plurality of cells 110 are fixed to each other by restraint member 210.

Restraint member 210 covers at least a part of first end edge 112aa and at least a part of second end edge 112ab in each of the plurality of cells 110. Restraint member 210 covers third end edge 112ac and fourth end edge 112ad in each of the plurality of cells 110.

Restraint member 210 includes a first restraint member 211 and a second restraint member 212. First restraint member 211 extends from one side to the other side of power storage module 100 in first direction D1. First restraint member 211 covers a part of first end edge 112aa, a part of second end edge 112ab, and third end edge 112ac in each of the plurality of cells 110. Second restraint member 212 extends from one side to the other side of power storage module 100 in first direction D1. First restraint member 211 and second restraint member 212 are spaced apart from each other. Second restraint member 212 covers another part of first end edge 112aa, another part of second end edge 112ab, and fourth end edge 112ad in each of the plurality of cells 110.

Plate member 220 has a plate-like outer shape. In the present embodiment, plate member 220 has a substantially uniform thickness. Plate member 220 extends in the horizontal direction. Plate member 220 extends in first direction D1. When viewed in up-down direction Z, plate member 220 intersects the plurality of cross members 3.

Plate member 220 is located above the plurality of cells 110 and restraint member 210, and is provided on restraint member 210. Between first restraint member 211 and second restraint member 212, plate member 220 faces upper surface portion 112a of each of the plurality of cells 110 with a gap being interposed. Examples of plate member 220 include a surface pressure distribution board and the like. The whole of buffer portion 200 may be a surface pressure distribution board. A material of plate member 220 will be described below.

Pack 300 houses power storage modules 100 and buffer portions 200. Pack 300 is configured to be fixable to the frame members of vehicle body 2 of vehicle 1.

As shown in FIG. 3, in vehicle 1 according to the present embodiment, an end of pack 300 on one side in second direction D2 is fixed to left side member 5a by a first fastening member 6a such as a bolt. An end of pack 300 on the other side in second direction D2 is fixed to right side member 5b by a second fastening member 6b such as a bolt.

The end of pack 300 on one side in second direction D2 may be fixed to left side sill 4a. The end of pack 300 on the other side in second direction D2 may be fixed to right side sill 4b.

As shown in FIGS. 3 and 4, pack 300 is disposed below the plurality of cross members 3. Pack 300 extends in first direction D1. When viewed in up-down direction Z, pack 300 is disposed to intersect the plurality of cross members 3. Pack 300 also functions as a floor member that defines a vehicle interior.

As shown in FIGS. 5 and 7, pack 300 includes an upper plate portion 310, a lower plate portion 320 and a peripheral wall portion 330. Upper plate portion 310 is disposed above the plurality of buffer portions 200. Lower plate portion 320 is disposed below power storage modules 100. Peripheral wall portion 330 extends downward from an outer perimeter end of upper plate portion 310. Peripheral wall portion 330 extends along the horizontal direction to surround the plurality of power storage modules 100. Peripheral wall portion 330 is connected to lower plate portion 320.

The material of buffer portion 200 will now be described. At least a part of each of buffer portions 200 is made of a material having rigidity higher than that of upper plate portion 310. Specifically, each plate member 220 is made of a material having rigidity higher than that of upper plate portion 310.

The specific material of plate member 220 is not particularly limited. Plate member 220 is preferably a resin member, for example. The resin member is preferably higher in heat resistance temperature than the material of upper plate portion 310. The resin member is preferably lower in heat conductivity than the material of upper plate portion 310. Since the resin member is such a material, an increase in temperature of the vehicle interior can be suppressed when power storage module 100 abnormally generates heat.

The resin member that constitutes plate member 220 may include a thermosetting resin. The resin member may be made of glass fiber reinforced plastic. The resin member may include a foaming resin. The heat resistance temperature of the foaming resin is preferably equal to or higher than 400° C.

Power storage device 10 may further include a plurality of first lower-side restraint members 410 and a plurality of second lower-side restraint members 420 (see FIGS. 7, 8 and the like).

The plurality of first lower-side restraint members 410 are provided to correspond to the plurality of power storage modules 100 in one-to-one relationship. Specifically, each of first lower-side restraint members 410 extends from one side to the other side of power storage module 100 in first direction D1. First lower-side restraint member 410 covers a part of first end surface portion 112e and a part of lower surface portion 112b in each of the plurality of cells 110.

The plurality of second lower-side restraint members 420 are provided to correspond to the plurality of power storage modules 100 in one-to-one relationship. Specifically, each of second lower-side restraint members 420 extends from one side to the other side of power storage module 100 in first direction D1. Second lower-side restraint member 420 covers a part of second end surface portion 112f and another part of lower surface portion 112b in each of the plurality of cells 110.

Power storage device 10 may further include a plurality of first adhesives 510. The plurality of first adhesives 510 are provided to correspond to the plurality of buffer portions 200 in one-to-one relationship. First adhesives 510 are disposed between upper plate portion 310 and buffer portions 200. First adhesives 510 join upper plate portion 310 to buffer portions 200. Thus, buffer portions 200 can suppress deformation of upper plate portion 310.

Power storage device 10 may further include a cooing plate 520. Cooing plate 520 is provided below the plurality of power storage modules 100. Cooing plate 520 may be provided above the plurality of power storage modules 100. A flow path (not shown) through which refrigerant such as air or a cooling liquid can flow is formed inside cooing plate 520.

Power storage device 10 may further include a tray 530 and a plurality of second adhesives 540. Tray 530 is provided below the plurality of power storage modules 100. The plurality of second adhesives 540 are provided to correspond to the plurality of power storage modules 100 in one-to-one relationship. Second adhesives 540 are disposed between power storage modules 100 and tray 530. Second adhesives 540 join the plurality of power storage modules 100 to tray 530.

As described above, power storage device 10 according to the embodiment of the present disclosure is power storage device 10 mountable on vehicle 1. Power storage device 10 includes: power storage module 100; and buffer portion 200. Power storage module 100 includes a plurality of cells 110. Buffer portion 200 is disposed on power storage module 100. The plurality of cells 110 are arranged in first direction D1, first direction D1 being a direction along a horizontal direction. Each of the plurality of cells 110 includes electrode assembly 111 and cell case 112 that houses electrode assembly 111. Cell case 112 includes upper surface portion 112a facing upward. Upper surface portion 112a includes first end edge 112aa and second end edge 112ab. First end edge 112aa is an end edge on one side in first direction D1. Second end edge 112ab is an end edge on the other side in first direction D1. First end edge 112aa and second end edge 112ab extend along second direction D2, second direction D2 being a direction along the horizontal direction and orthogonal to first direction D1. Buffer portion 200 covers first end edge 112aa and second end edge 112ab in each of the plurality of cells 110.

In the above-described configuration, when a load is input to buffer portion 200 from above, the load received by buffer portion 200 is further transmitted to the plurality of cells 110. Buffer portion 200 covers first end edge 112aa and second end edge 112ab in each of the plurality of cells 110. Therefore, the load transmitted to the plurality of cells 110 is distributed to first end edge 112aa and second end edge 112ab in each of the plurality of cells 110. Therefore, input of the load to the upper surfaces of cells 110 from above can be reduced.

Furthermore, in the present embodiment, since input of the load to the upper surfaces of cells 110 is reduced, deformation of upper surface portion 112a and deformation of electrode assembly 111 can be suppressed. As a result, a short circuit in electrode assembly 111 can be suppressed.

Power storage device 10 further includes pack 300. Pack 300 houses power storage module 100 and buffer portion 200. Pack 300 is fixable to vehicle body 2 of vehicle 1. Pack 300 includes upper plate portion 310 and lower plate portion 320. Upper plate portion 310 is disposed above buffer portion 200. Lower plate portion 320 is disposed below power storage module 100. At least a part of buffer portion 200 is made of a material having rigidity higher than that of upper plate portion 310.

According to the above-described configuration, when the load is input from above pack 300 through pack 300 to buffer portion 200, buffer portion 200 is relatively hard to bend. Thus, bending of buffer portion 200 with a place of contact between first end edge 112aa and second end edge 112ab as a fulcrum can be suppressed. Thus, input of the load to the upper surfaces of cells 110 from above can be further reduced.

Buffer portion 200 includes: restraint member 210; and plate member 220. Restraint member 210 extends from one side to the other side of power storage module 100 in first direction D1. Restraint member 210 covers at least a part of first end edge 112aa and at least a part of second end edge 112ab in each of the plurality of cells 110. Plate member 220 is located above the plurality of cells 110 and restraint member 210 and is provided on restraint member 210.

According to the above-described configuration, relative displacement of the plurality of cells 110 in first direction D1 is suppressed by buffer portion 200. Therefore, the load from above can be effectively distributed by first end edge 112aa and second end edge 112ab.

Power storage device 10 further includes pack 300. Pack 300 houses power storage module 100 and buffer portion 200. Pack 300 is fixable to vehicle body 2 of vehicle 1. Pack 300 includes upper plate portion 310 and lower plate portion 320. Upper plate portion 310 is disposed above buffer portion 200. Lower plate portion 320 is disposed below power storage module 100. Plate member 220 is made of a material having rigidity higher than that of upper plate portion 310.

According to the above-described configuration, when the load is input from above pack 300 through pack 300 to buffer portion 200, plate member 220 is relatively hard to bend. Thus, bending of plate member 220 with a place of contact with restraint member 210 as a fulcrum can be suppressed. Thus, input of the load to the upper surfaces of cells 110 from above can be further reduced.

In power storage device 10 according to the embodiment of the present disclosure, in each of the plurality of cells 110, upper surface portion 112a further includes third end edge 112ac and fourth end edge 112ad. Third end edge 112ac is an end edge on one side in second direction D2. Fourth end edge 112ad is an end edge on the other side in second direction D2. Third end edge 112ac and fourth end edge 112ad extend along first direction D1. Restraint member 210 includes first restraint member 211 and second restraint member 212. First restraint member 211 extends from one side to the other side of power storage module 100 in first direction D1. First restraint member 211 covers a part of first end edge 112aa, a part of second end edge 112ab, and third end edge 112ac in each of the plurality of cells 110. Second restraint member 212 extends from one side to the other side of power storage module 100 in first direction D1. Second restraint member 212 covers another part of first end edge 112aa, another part of second end edge 112ab, and fourth end edge 112ad in each of the plurality of cells 110.

According to the above-described configuration, the load from above power storage device 10 can also be distributed to third end edge 112ac and fourth end edge 112ad in each of the plurality of cells 110. Thus, input of the load to the upper surfaces of cells 110 from above can be further reduced.

In power storage device 10 according to the embodiment of the present disclosure, first restraint member 211 and second restraint member 212 are spaced apart from each other. Between first restraint member 211 and second restraint member 212, plate member 220 faces upper surface portion 112a of each of the plurality of cells 110 with a gap being interposed.

According to the above-described configuration, when plate member 220 is bent with first restraint member 211 and second restraint member 212 as fulcrums, contact of plate member 220 with a portion other than the end edges of upper surface portion 112a can be suppressed.

Vehicle 1 according to an embodiment of the present disclosure includes: above-described power storage device 10; and vehicle body 2 having power storage device 10 fixed thereto. A front-rear direction of vehicle body 2 is first direction D1 in power storage device 10. Vehicle body 2 includes cross member 3 extending in a left-right direction of vehicle body 2. Cross member 3 is located above power storage module 100 and buffer portion 200.

According to the above-described configuration, buffer portion 200 intersects cross member 3 when viewed in up-down direction Z. Therefore, the rigidity of vehicle 1 as a whole can be increased.

The configuration of buffer portion 200 is not limited to the above-described configuration. FIG. 9 is a schematic cross-sectional view of a power storage module and a buffer portion according to a modification. FIG. 9 is illustrated in the same cross-sectional view as FIG. 8 in the present embodiment.

As shown in FIG. 9, in the present modification, between first restraint member 211 and second restraint member 212, a plate member 220A may be in contact with first end edge 112aa and second end edge 112ab in each of the plurality of cells 110. According to this configuration, not only first restraint member 211 and second restraint member 212 but also plate member 220A can distribute a load to first end edge 112aa and second end edge 112ab in each of the plurality of cells 110.

Specifically, plate member 220A has a flat plate-shaped portion 221 and a protruding portion 222. Flat plate-shaped portion 221 has a substantially uniform thickness in up-down direction Z. Protruding portion 222 is a portion protruding downward from flat plate-shaped portion 221. Protruding portion 222 is in contact with first end edge 112aa and second end edge 112ab in each of the plurality of cells 110.

In the description of the above-described embodiment, the features that can be combined may be combined mutually.

Although the embodiment of the present disclosure has been described, it should be understood that the embodiment disclosed herein is illustrative and non-restrictive in every respect. The scope of the present disclosure is defined by the terms of the claims, and is intended to include any modifications within the scope and meaning equivalent to the terms of the claims.

What is claimed is:

1. A power storage device mountable on a vehicle, the power storage device comprising:
a power storage module including a plurality of cells; and
a buffer portion disposed on the power storage module, wherein
the plurality of cells are arranged in a first direction, the first direction being a direction along a horizontal direction,
each of the plurality of cells includes an electrode assembly and a cell case that houses the electrode assembly,
the cell case includes an upper surface portion facing upward,
the upper surface portion includes a first end edge that is an end edge on one side in the first direction, and a second end edge that is an end edge on the other side in the first direction,
the first end edge and the second end edge extend along a second direction, the second direction being a direction along the horizontal direction and orthogonal to the first direction, and
the buffer portion covers the first end edge and the second end edge in each of the plurality of cells.

2. The power storage device according to claim 1, further comprising
a pack that houses the power storage module and the buffer portion and is fixable to a vehicle body of the vehicle, wherein
the pack includes an upper plate portion disposed above the buffer portion, and a lower plate portion disposed below the power storage module, and
at least a part of the buffer portion is made of a material having rigidity higher than that of the upper plate portion.

3. The power storage device according to claim 1, wherein
the buffer portion includes:
a restraint member; and
a plate member,
the restraint member extends from one side to the other side of the power storage module in the first direction and covers at least a part of the first end edge and at least a part of the second end edge in each of the plurality of cells, and
the plate member is located above the plurality of cells and the restraint member and is provided on the restraint member.

4. The power storage device according to claim 3, further comprising
a pack that houses the power storage module and the buffer portion and is fixable to a vehicle body of the vehicle, wherein
the pack includes an upper plate portion disposed above the buffer portion, and a lower plate portion disposed below the power storage module, and
the plate member is made of a material having rigidity higher than that of the upper plate portion.

5. The power storage device according to claim 3, wherein
in each of the plurality of cells, the upper surface portion further includes a third end edge that is an end edge on one side in the second direction, and a fourth end edge that is an end edge on the other side in the second direction,
the third end edge and the fourth end edge extend along the first direction,
the restraint member includes a first restraint member and a second restraint member,
the first restraint member extends from one side to the other side of the power storage module in the first direction,
the first restraint member covers a part of the first end edge, a part of the second end edge, and the third end edge in each of the plurality of cells,
the second restraint member extends from one side to the other side of the power storage module in the first direction, and
the second restraint member covers another part of the first end edge, another part of the second end edge, and the fourth end edge in each of the plurality of cells.

6. The power storage device according to claim 5, wherein
the first restraint member and the second restraint member are spaced apart from each other, and
between the first restraint member and the second restraint member, the plate member faces the upper surface portion of each of the plurality of cells with a gap being interposed.

7. The power storage device according to claim 5, wherein
the first restraint member and the second restraint member are spaced apart from each other, and
between the first restraint member and the second restraint member, the plate member is in contact with the first end edge and the second end edge in each of the plurality of cells.

8. A vehicle comprising:
the power storage device as recited in claim 1; and
a vehicle body having the power storage device fixed thereto, wherein
a front-rear direction of the vehicle body is the first direction in the power storage device,
the vehicle body includes a cross member extending in a left-right direction of the vehicle body, and
the cross member is located above the power storage module and the buffer portion.
